(19) United States
(12) Patent Application Publication
(10) Pub. No.: US 2011/0278352 A1
(43) Pub. Date: Nov. 17, 2011

(54) Double Postcard and Intermediate Form with Security Features

(76) Inventor: David Yost, Roanoke, VA (US)

(21) Appl. No.: 13/093,353

(22) Filed: Apr. 25, 2011

Related U.S. Application Data
(63) Continuation-in-part of application No. 13/076,108, filed on Mar. 30, 2011.
(60) Provisional application No. 61/319,523, filed on Mar. 31, 2010.

(51) Int. Cl. B42D 15/04; B42D 15/00

(52) U.S. Cl. 229/92.8; 229/300; 283/72

(57) ABSTRACT

An intermediate form is designed for folding to a double postcard mailer that has dimensions and sealing features that meet U.S. Postal Service standards for postcard sealing and postal rates. The intermediate form includes a single ply of stock having a first face and a second face, a first and a second end edge, and a first and a second side edge. The first and the second side edges are disposed in a substantially perpendicular orientation to the first and the second end edges. The single ply includes a fold line extending at a substantially transverse orientation to and between the first and the second side edges. The fold line is disposed to define a first panel and a second panel in the single ply. The first panel and/or the second panel has/have postcard dimensions.

### RELATED APPLICATIONS

This application is a continuation-in-part patent application claiming priority to U.S. patent application Ser. No. 13/076,108 filed Mar. 30, 2011, which claims priority to U.S. provisional patent application Ser. No. 61/319,523 filed Mar. 31, 2010, the disclosures of which are incorporated herein in their entireties by reference.

### TECHNICAL FIELD

A double postcard and an intermediate form that folds to a double postcard are provided that meets U.S. Postal Service standards for postcards and include one or more security features.

### BACKGROUND

Postcard mailers and postcards continue to be subject to U.S. Postal Service rates that are significantly less than postal rates for first class mail. Postcard mailers traditionally include double postcards having two attached postcards with one postcard configured to detach from the double postcard and to serve as a reply or return postcard. The reply or return postcard is a single postcard sent via mail for any of a variety of purposes. Use of double and single reply/return postcards, therefore, can provide cost savings as incentives to use such forms for various mailings. However, postcard mailers are subject to U.S. Postal Service standards that specify content and sealing requirements. Such standards require that the double postcard may not be sealed against inspection of the inner surfaces of the double postcard. Such inspection is performed, typically by separating the side edges, to confirm that the reply/return postcard does not include any information that is not permitted under postcard rates by the U.S. Postal Service.

U.S. Postal Service requirements, therefore, do not permit sealing along the sides of a double postcard, and only allow end edges, such as top and bottom end edges, of a double postcard to be sealed. More specifically, U.S. Postal Service regulation no. 201.1.2.8.c recites, “Any sealing on the left and right side of the cards, no matter the sealing process used, is not permitted.”

Given these requirements some double postcard designs employ adhesive/cohesive along or adjacent to side edges of the double postcard. Sensitive areas of such postcard mail pieces include the left and right side edges, either of which may serve as a lead edge for feeding a postcard mail piece through postal equipment. The side edges of postcard mail pieces, therefore, are susceptible to catching or tearing or other damage during processing and mailing, particularly if any applications of adhesive/cohesive occur along or adjacent to a lead side edge. Importantly, any damage or tearing occurring during mailing and processing of a double postcard mail piece may result in damage to or tearing of the reply or return postcard that can interfere with mailing and processing of the reply/return postcard with postal equipment.

In addition, given the U.S. Postal Service postcard requirements and regulation to permit inspection of inner surfaces of the double postcard from along the side edges of these mail pieces, private or sensitive information or indicia are not sent to intended recipients using postcard mail pieces. Therefore, companies and institutions, such as financial institutions, cannot take advantage of lower postal rates by sending private or sensitive information using postcard mail pieces where such information or indicia may include personal identification numbers (PINs), bank account numbers, passwords, authorization numbers, and any other information or indicia restricted with respect knowledge and/or use of such information and indicia by one or more intended recipients and/or authorized end-users. Such private or sensitive information and indicia would be visible to the casual observer or postal handler. Solutions to conceal or to hide private or sensitive information and indicia, including labels, patches, and other coverings, may create a postcard mail piece that does not meet the U.S. Postal Service regulation with respect to the nature and location of labels and patches along double postcards. In addition, if such labels, patches, and other coverings provide substantially permanent coverage, such devices would not permit inspection of the inner surfaces of a double postcard by the U.S. Postal Service during processing.

Thus, a double postcard configured to help to prevent or to at least reduce the incidence of damage or tearing, or “fiber tear,” along the double postcard, and configured to satisfy U.S. Postal Service standards for sealing and postcard postal rates, is desirable. In addition, a double postcard configured to help to prevent or to at least reduce the incidence of damage or tearing during processing and mailing to thereby provide a damage- or tear-free, rigid and stable return or reply postcard is desirable.

Further, a double postcard configured to securely transmit private or sensitive information and indicia to intended recipient(s) and/or authorized end-users that does not require any patch, label or other covering to conceal or hide such information and indicia is desirable. A double postcard including one or more security features configured to help to substantially obscure or to help to hide or camouflage private or sensitive information and indicia applied thereto, and configured to permit intended recipient(s) and/or authorized end-users of such private or sensitive information and indicia to at least temporarily view such information and indicia, is desirable. Such double postcard would also permit at least temporary viewing of the information and indicia during inspection by the U.S. Postal Service.

### SUMMARY

In general, in one aspect, the invention provides an intermediate form for folding to a mailer having postcard dimensions. The intermediate form comprises a single ply of stock having a first face and a second face, a first and a second end edge, and a first and a second side edge, the first and the second side edges being disposed in a substantially perpendicular orientation to the first and the second end edges. The form also includes a fold line, extending at a substantially transverse orientation to and between the first and the second side edges. The fold line is disposed to define at least a first panel and at least a second panel with at least one panel having postcard dimensions. The form further includes at least one security feature disposed along one face of the intermediate form, such that, when the intermediate form folds along the fold line, the at least one security feature is disposed along an inner surface of the folded intermediate form. The at least one security feature includes one or more thermochromic inks. Each thermochromic ink is configured to temporarily change color in response to changes in temperatures of the thermochromic ink. The intermediate form also includes private or sensitive information or indicia disposed along at least a portion of the at least one security feature.

Implementations of the invention may include one or more of the following features. At least a portion of the private or sensitive information or indicia may be disposed under and/or over the at least one security feature. The at least one security feature may include a pattern of one or more thermochromic inks. The pattern may include one or more letters, one or more numbers, and/or one or more other configurations. The at least one security feature may also include one or more layers of the one or more thermochromic inks.

Implementations of the invention may also include one or more of the following features. The one or more thermochromic inks may define the at least one security feature so that the private or sensitive information or indicia may be at least partially camouflaged. A temporary change in color of each thermochromic ink may permit at least a portion of the private or sensitive information or indicia to be temporarily and at least partially visible or discernible. Changes in temperatures of each thermochromic ink may include increases in temperatures.

The fold line may be configured to permit the intermediate form to fold along the fold line to form a double postcard mailer having postcard dimensions sufficient for postcard postal rates. The double postcard mailer may include recipient information along an outer surface and return addressee information along the inner surface.

Implementations of the invention may further include one or more of the following features. The intermediate form may include at least a first application of adhesive disposed adjacent to at least the first or the second end edge and extending along at least a portion of the end edge. The intermediate form may also include a second application of adhesive disposed adjacent to the fold line and substantially near a center point along the fold line. The center point may be disposed substantially equidistant from the first and the second side edges and the second application of adhesive may be disposed closer to the center point than to the first side edge or the second side edge. The first application and the second application of adhesive may include pressure sensitive cohesive, pressure sensitive adhesive, re-moist adhesive, hot or cold melt adhesive and/or hot or cold melt glue.

In another aspect, the invention provides an intermediate form for folding to a mailer having postcard dimensions. The intermediate form comprises a single ply of stock having a first face and a second face, a first and a second end edge, and a first and a second side edge. The first and the second side edges are disposed in a substantially perpendicular orientation to the first and the second end edges. The intermediate form also includes a fold line, extending at a substantially transverse orientation to and between the first and the second side edges. The fold line is disposed to define at least a first panel and at least a second panel with at least one panel having postcard dimensions. The intermediate form further includes a first application of adhesive disposed adjacent to the first end edge and extending along at least a portion of the first end edge, and also includes a second application of adhesive disposed adjacent to the second end edge and extending along at least a portion of the second end edge. The intermediate form includes at least one security feature disposed along one face of the intermediate form, such that, when the intermediate form folds along the fold line, the at least one security feature is disposed along an inner surface of the folded intermediate form. The at least one security feature includes one or more thermochromic inks. Each thermochromic ink is configured to temporarily change color in response to changes in temperatures of the thermochromic ink. The intermediate form also includes private or sensitive information or indicia disposed along at least a portion of the at least one security feature.

In a further aspect, the invention provides a double postcard mailer having postcard dimensions. The double postcard mailer comprises a single ply of stock having a first face and a second face, a first and a second end edge, and a first and a second side edge, the first and the second side edges being disposed in a substantially perpendicular orientation to the first and the second end edges. The double postcard mailer also includes a fold line extending at a substantially transverse orientation to and between the first and the second side edges. The fold line is disposed to define at least a first panel and at least a second panel with at least one panel having postcard dimensions, and is also configured to permit the single ply to fold along the fold line to form the double postcard mailer. The double postcard mailer includes a first application of adhesive disposed adjacent to the first end edge, extending along at least a portion of the first end edge, and a second application of adhesive disposed adjacent to the second end edge, extending along at least a portion of the second end edge. The intermediate form also includes at least one security feature disposed along one face of the intermediate form, such that, when the intermediate form folds along the fold line, the at least one security feature is disposed along an inner surface of the folded intermediate form. The at least one security feature includes one or more thermochromic inks. Each thermochromic ink is configured to temporarily change color in response to changes in temperatures of the thermochromic ink. The double postcard mailer further includes private or sensitive information or indicia disposed along at least a portion of the at least one security feature.

In another aspect, the invention provides an intermediate form configured for folding to a mailer. The mailer may include a double postcard having postcard dimensions. The intermediate form includes a single ply of stock having a first face and a second face, a first and a second end edge, and a first and a second side edge. The first and the second side edges are disposed in a substantially perpendicular orientation to the first and the second end edges. The intermediate form includes a fold line extending at a substantially transverse orientation to and between the first and the second side edges, and is disposed to define a first panel and a second panel. One or both of the first and the second panels has/have postcard dimensions. The fold line may intersect one or both of the first and the second side edges. The intermediate form further includes a first application of adhesive disposed adjacent to the fold line and substantially near a center point along the fold line that is disposed substantially equidistant from the first and the second side edges. The first application of adhesive is disposed closer to the center point than to the first side edge and/or the second side edge. The intermediate form may also include a second application of adhesive disposed adjacent to at least the first or the second end edge and extending along at least a portion of the end edge. The second application of adhesive may be disposed substantially parallel to the edge, and/or may be flush to the end edge. Where the intermediate form folds along the fold line to the double postcard configuration, the first and the second side edges of the double postcard permit inspection of the inner surfaces of the folded form in face-to-face relation.

Implementations of the invention may include one or more of the following features. The first application of adhesive includes at least two adhesive spots disposed along one side of the fold line. Each adhesive spot may define a length, such that, an outer edge of at least one adhesive spot is closer to the center point along the fold line than to the first side edge or the second side edge. Alternatively, each adhesive spot may define a length, such that, an outer edge of each adhesive spot is closer to the center point along the fold line than to the first side edge or the second side edge. The two adhesive spots may be disposed in a substantially linear orientation relative to one another. The two adhesive spots also may be disposed substantially equidistant from the fold line. The fold line may include a line of weakness configured to separate and to detach the first panel and the second panel from one another.

Implementations of the invention also may include one or more of the following features. The first application of adhesive and the second application of adhesive may be disposed along the same side of the fold line. The first application and the second application of adhesive may include at least one of: pressure sensitive adhesive, re-moist adhesive, hot or cold melt adhesive and hot or cold melt glue.

Implementations of the invention may further include one or more of the following features. A third application of adhesive may be disposed along a side of the fold line opposite to a side of the fold line along which the first application of adhesive is disposed. The third application of adhesive may be disposed adjacent to the fold line and substantially near the center point along the fold line and closer to the center point than to the first side edge or the second side edge. The third application of adhesive may be disposed substantially opposite to the first application of adhesive. Each of the first and the third applications of adhesive may define a length, such that, at least one outer edge of each of the first and the third applications of adhesive is closer to the center point along the fold line than to the first side edge or the second side edge. As the intermediate form folds along the fold line to the double postcard configuration, at least a portion of the first application of adhesive may contact at least a portion of the third application of adhesive. The first and the third applications of adhesive may include complementary patterns of adhesive including, but not limited to, complementary patterns of pressure sensitive cohesive.

In addition, implementations of the invention may include one or more of the following features. An additional or fourth application of adhesive may be disposed adjacent to the end edge opposite to the end edge along which the second application of adhesive is disposed. The additional or fourth application of adhesive may extend along at least a portion of the end edge. The additional or fourth application of adhesive may be disposed substantially parallel to the edge, and/or may be flush to the end edge.

In another aspect, the invention provides an intermediate form configured for folding to a mailer. The mailer may include a double postcard having postcard dimensions. The intermediate form includes a single ply of stock having a first face and a second face, a first and a second end edge, and a first and a second side edge. The first and the second side edges are disposed in a substantially perpendicular orientation to the first and the second end edges. The intermediate form includes a fold line extending at a substantially transverse orientation to and between the first and the second side edges. The fold line is disposed to define a first panel and a second panel. One or both of the first and the second panels has/have postcard dimensions. The fold line may intersect one or both of the first and the second side edges. The intermediate form further includes a first application of adhesive disposed adjacent to the fold line and substantially on a center point along the fold line that is disposed substantially equidistant from the first and the second side edges. The first application of adhesive has dimensions, such that, at least one outer edge of the first application of adhesive is closer to the center point than to the first side edge or the second side edge. The intermediate form may also include a second application of adhesive disposed adjacent to at least the first or the second end edge and extending along at least a portion of the end edge. Where the intermediate form folds along the fold line to the double postcard configuration, the first and the second side edges of the double postcard permit inspection of the inner surfaces of the folded form in face-to-face relation.

In a further aspect, the invention provides an intermediate form configured for folding to a mailer. The mailer may include a double postcard having postcard dimensions. The intermediate form includes a single ply of stock having a first face and a second face, a first and a second end edge, and a first and a second side edge. The first and the second side edges are disposed in a substantially perpendicular orientation to the first and the second end edges. The intermediate form includes a fold line extending at a substantially transverse orientation to and between the first and the second side edges. The fold line is disposed to define a first panel and a second panel. One or both of the first and the second panels has/have postcard dimensions. The fold line may intersect one or both of the first and the second side edges. The intermediate form also includes a first application of adhesive including at least two adhesive spots disposed adjacent to and along each side of the fold line, such that, the fold line is disposed between the two adhesive spots. Each adhesive spot may have dimensions, such that, at least one outer edge of each adhesive spot is disposed closer to a center point along the fold line than to the first side edge or the second side edge. The center point may be positioned along the fold line substantially equidistant from the first and the second side edges. The intermediate form may also include a second application of adhesive disposed adjacent to at least the first or the second end edge and extending along at least a portion of the end edge. Where the intermediate form folds along the fold line to the double postcard configuration, the first and the second side edges of the double postcard permit inspection of the inner surfaces of the form in face-to-face relation.

Various aspects of the invention may include one or more of the following features, advantages and/or capabilities. The intermediate form according to the invention can be configured and can have dimensions, such that, when folded to the double postcard configuration, the double postcard has dimensions and is sealed in compliance with U.S. Postal Service standards for postcards and postcard postal rates. The intermediate form can include one or more applications of adhesive/cohesive that can help to ensure that the resulting double postcard complies with U.S. Postal Service standards for sealing, which prohibit sealing along the sides of the double postcard, such that, sealing does not prevent inspection of inner surfaces of the folded double postcard. One or more applications of adhesive/cohesive along the intermediate form and the double postcard can help to eliminate or to at least reduce the incidence of damage to or catching, jamming or tearing of the intermediate form and the double postcard during processing or during mailing and processing with U.S. Postal Service equipment. As a result, the intermediate form and the double postcard according to the invention can help to promote ease and efficiency in handling and sorting the double postcard and the return or reply postcard with U.S. Postal Service equipment. In addition, the double postcard and the intermediate form can include one or more applications of adhesive/cohesive that can help to retain the double postcard in the folded configuration, especially in the event a portion of the double postcard is damaged or torn. Further, the double postcard and the intermediate form can include one or more applications of adhesive/cohesive applications that help to eliminate or to at least reduce a puckering effect along the middle of the folded double postcard.

In addition, various aspects of the invention may include one or more of the following features, advantages and/or capabilities. The intermediate form according to the invention can be configured, such that, when folded, the intermediate form can form a double postcard configuration having dimensions and sealing characteristics in compliance with U.S. Postal Service standards. The intermediate form can include one or more security features that enable the intermediate form to serve as an intermediate for a postcard mailer that may be used to securely transmit private or sensitive information or indicia to one or more intended recipients and/or authorized end-users using the U.S. Postal Service. Each security feature can be configured with one or more thermochromic inks that help to conceal or help to hide or to camouflage any private or secure information or indicia applied under and/over the one or more security features. Each thermochromic ink may be formulated to change color in response to changes in temperatures. For instance, each thermochromic ink may be formulated to change color in response to increases in temperatures. Color changes of security feature thermochromic inks may help to enable any private or sensitive information or indicia under and/or over a security feature to be temporarily and at least partially discernible. Thus, U.S. Postal Service personnel may inspect the postcard mailer to determine if such form is in compliance with its postcard regulations without comprising the privacy of the information or indicia being transmitted with the postcard mailer.

### BRIEF DESCRIPTION OF THE DRAWINGS

FIG. 1A illustrates a plan view of one aspect of the invention providing a double postcard intermediate form;

FIGS. 1B-1E illustrate plan views of different configurations of the intermediate form shown in FIG. 1A;

FIG. 2 illustrates a plan view of another aspect of the invention providing a double postcard intermediate form;

FIG. 3 illustrates a plan view of a further aspect of the invention providing a double postcard intermediate form;

FIG. 4 illustrates a plan view of another aspect of the invention providing a double postcard intermediate form;

FIGS. 5A and 5B illustrate an intermediate form according to the invention in a folding condition and as a double postcard;

FIGS. 6A and 6B illustrate another configuration of the intermediate form shown in FIGS. 5A and 5B;

FIG. 7 illustrates a plan view of a further aspect of the invention providing a double postcard intermediate form including at least one security feature;

FIG. 8 illustrates a plan view of the intermediate form shown in FIG. 7;

FIG. 9 illustrates a plan view of the intermediate form shown in FIG. 1A including at least one security feature; and

FIGS. 10A and 10B illustrate the intermediate form according to the invention shown in FIG. 1A and in FIG. 7 in a folding condition and as a double postcard.

### DETAILED DESCRIPTION

The invention provides a double postcard, and an intermediate form designed and configured to serve as a double postcard when printed and folded. The double postcard may serve any of a number of purposes and may include variable and non-variable information and indicia. The double postcard has dimensions that comply with U.S. Postal Service standards for double postcards as are described above. In particular, the double postcard and the intermediate form comply with the contact and the sealing requirements of the U.S. Postal Service so that the double postcard according to the invention qualifies for postal rates for postcards.

The intermediate form according to the invention defines, e.g., by a fold line, a double postcard or two attached postcards with at least one postcard having U.S. Postal Service dimensions to qualify for postcard rates. The intermediate form is designed and configured, such that, one of the postcards is detachable and serves as a return or reply postcard for any of a variety of purposes. The double postcard and the intermediate form according to the invention includes an application of adhesive and/or cohesive disposed on, about and/or near a point, e.g., a center point, along a fold line of the intermediate form, as described below in detail. The fold line extends traversely between each side edge of the intermediate form. The application of adhesive and/or cohesive is configured, such that, a portion of the adhesive, e.g., an outer edge or end of adhesive, is closer to the point along the fold line than to at least one side edge. In addition, the intermediate form further includes an application of adhesive and/or cohesive adjacent to and along at least one end edge of the intermediate form to help to secure the end edges of the form.

Applications of adhesive/cohesive help secure the intermediate form in a folded configuration when the intermediate form folds to a double postcard. In addition, applications of adhesive/cohesive help retain the double postcard in the folded configuration during processing and/or mailing. Applications of adhesive/cohesive also ensure that the resulting double postcard complies with U.S. Postal Service standards for sealing, which prohibit sealing along the sides of the double postcard, such that, the sealing does not prevent inspection, but permits examination of the inner surfaces of the folded double postcard. Applications of adhesive/cohesive further help to secure the double postcard and to retain the double postcard in a folded orientation, especially in the event a portion of the double postcard is damaged or torn during processing or mailing. In addition, applications of adhesive/cohesive help to reduce or to eliminate a puckering effect along the middle of the folded double postcard. Further, applications of adhesive/cohesive help to promote ease in handling and sorting the double postcard with U.S. Postal Service equipment.

As used to describe the invention, the term “adhesive” describing various applications of adhesive according to the invention may include any type of adhesive or cohesive including, but not limited to, pressure sensitive adhesive, re-moist adhesive, hot or cold melt adhesive, hot or cold melt glue, and pressure sensitive cohesive.

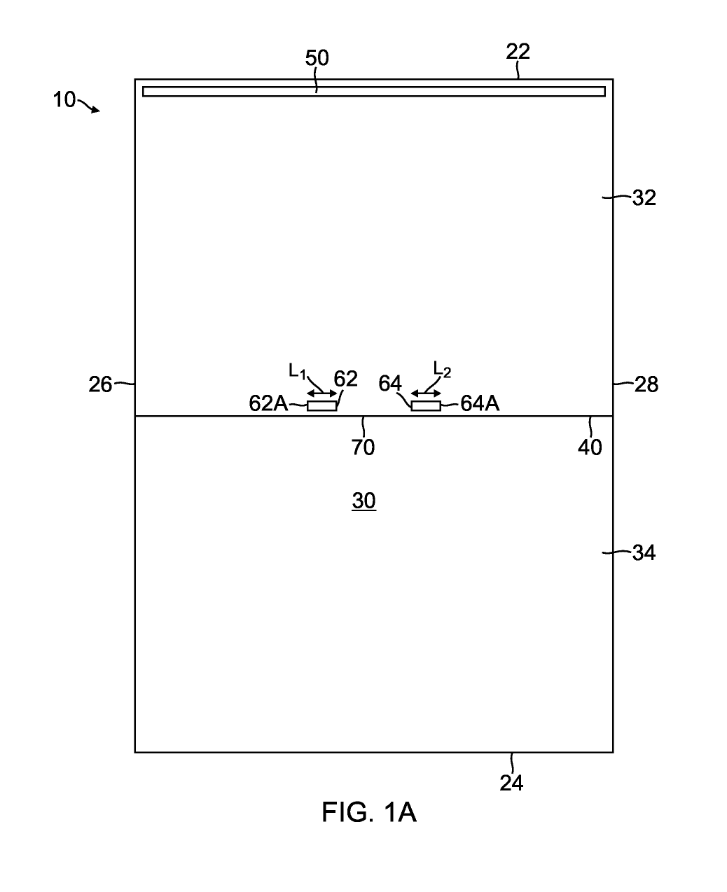

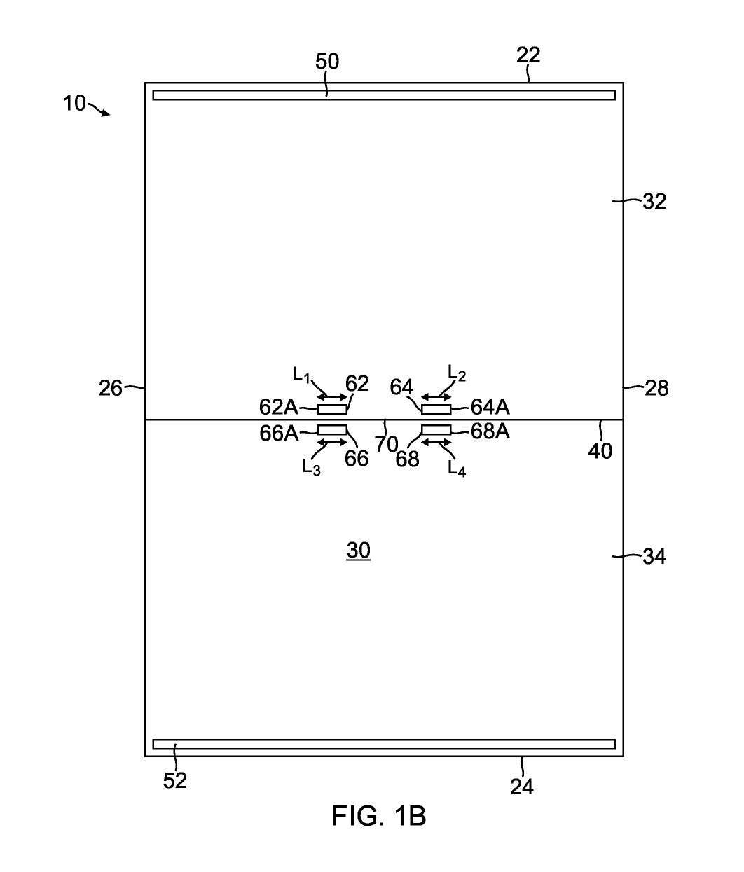

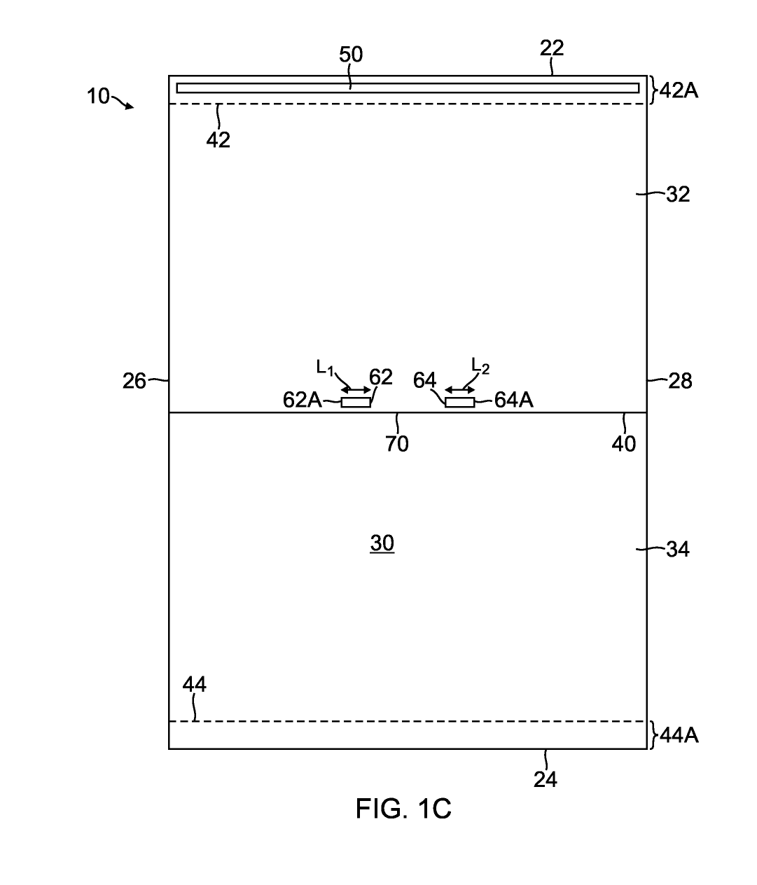

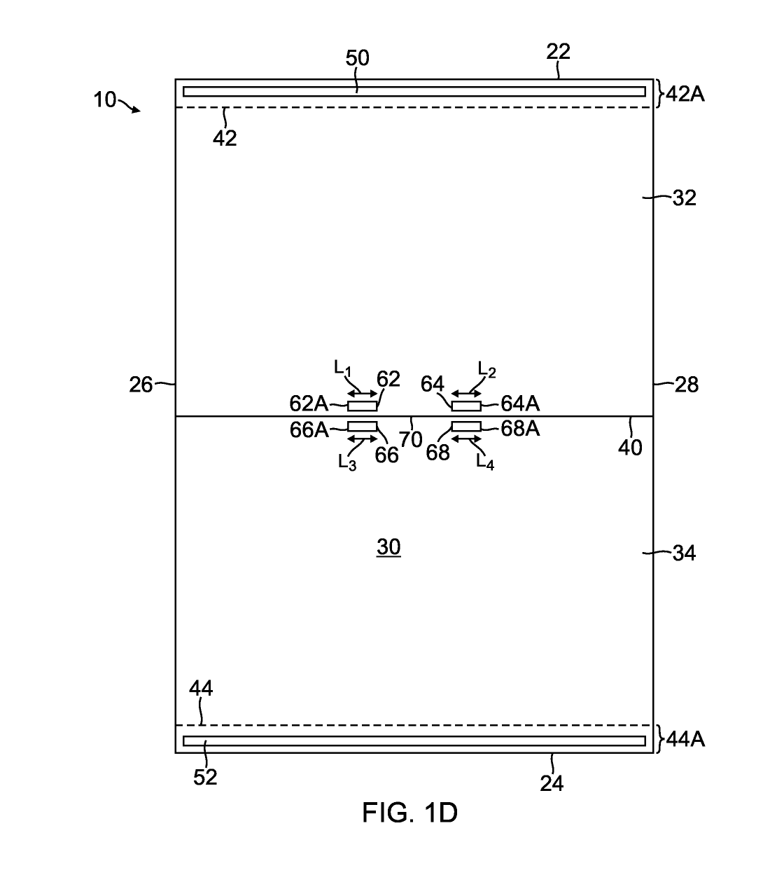

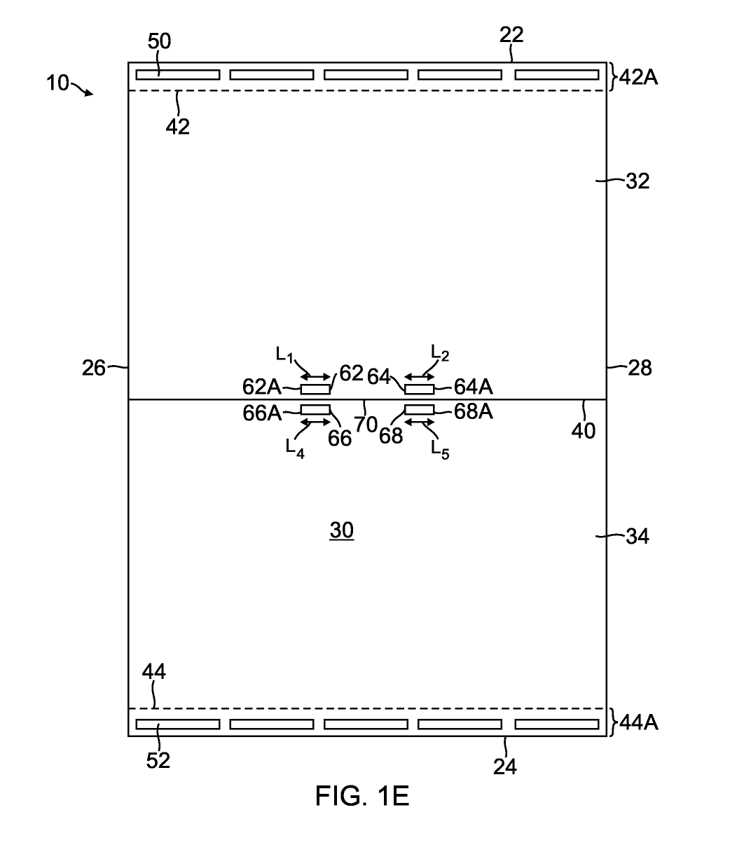

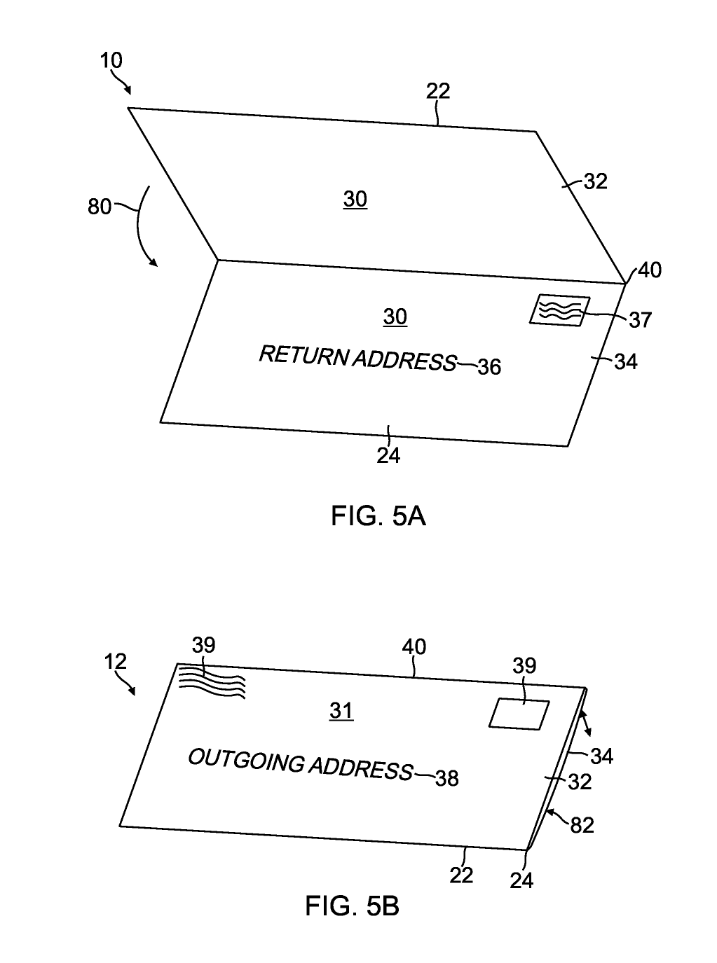

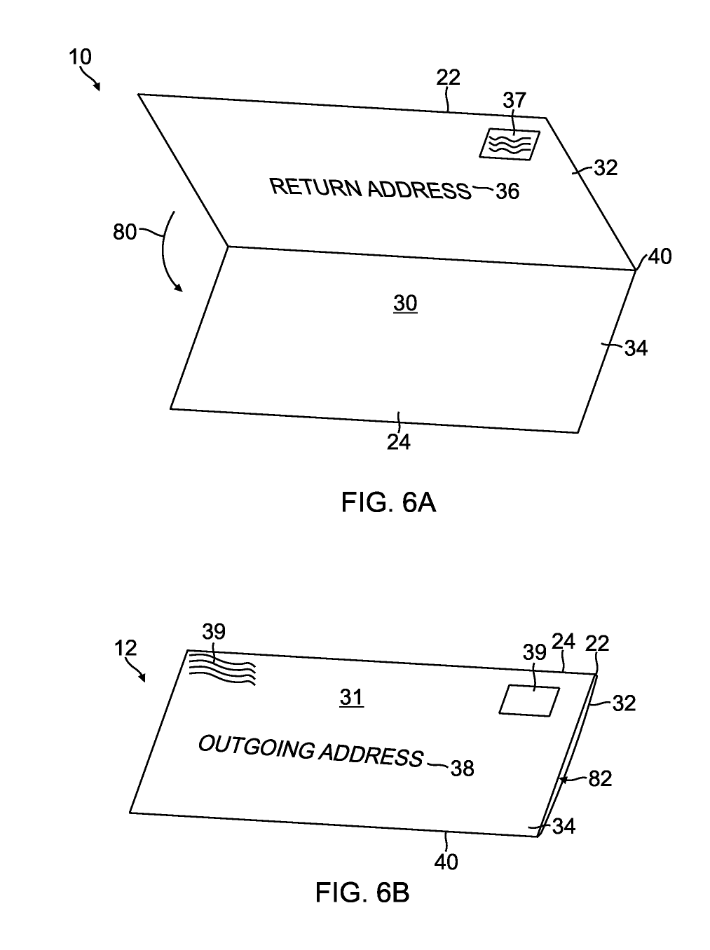

Referring to FIG. 1A, in one aspect, the invention provides a double postcard intermediate form 10 designed to fold to a double postcard having postcard dimensions, as described in detail below with reference to FIGS. 5A-5B and 6A-6B. The intermediate form 10 is configured to help to permit inspection of the inner surfaces of the intermediate form 10 that are disposed in face-to-face relation when the intermediate form 10 folds to the double postcard. The intermediate form 10 includes a single ply of stock having a substantially rectangular shape, although the invention is not so limited and anticipates other configurations of the intermediate form 10. The stock may include one or more materials suitable to receive printing and/or imaging including, but not limited to, 100 lb or 125 lb stock, such as Boise® Tag™ from Boise, Inc. of Boise, Id.; 91 lb stock, such as from International Paper of Memphis, Tenn.; 75 lb card stock; and any other stock having sufficient basis weight.

The intermediate form 10 has a first face 30 and a second face (not shown in FIG. 1A), and includes a first end edge 22 and a second end edge 24 that are substantially parallel to one another. The intermediate form 10 also includes a first side edge 26 and a second side edge 28 that are substantially parallel to one another and are disposed at a substantially perpendicular orientation to the first and second end edges 22 and 24.

The intermediate form 10 defines a fold line 40 between the first and second side edges 26 and 28. The fold line 40 extends at a substantially transverse orientation to and between the first and the second side edges 26 and 28 and may intersect one or both side edge 26 and 28. The fold line 40 is configured to permit the intermediate form 10 to fold along the fold line 40. The fold line 40 is positioned, such that, the fold line 40 defines a first panel 32 and a second panel 34. The fold line 40 may be disposed along the intermediate form 10, such that, the first panel 32 may serve as a first postcard and/or the second panel 34 may serve as a second postcard. In one configuration of the intermediate form 10 according to the invention, at least the first or the second postcard 32 or 34 defines dimensions acceptable to meet U.S. Postal Service rates for postcards. In addition, the intermediate form 10 may define the fold line 40, such that, the first panel or postcard 32 and the second panel or postcard 34 have substantially the same dimensions, e.g., dimensions that meet U.S. Postal Service standards for postcards.

The fold line 40 may have any configuration that permits folding, or may include a line of weakness including, but not limited to, a line of perforations, a line of score lines, a line of die cuts, a line of other configurations and combinations thereof that permit the intermediate form 10 to fold along the fold line 40. In addition, the fold line 40 may include a line of weakness that permits the first postcard 32 and the second postcard 34 to detach and separate from one another.

The intermediate form 10 further includes a first application of adhesive 62 and 64 adjacent to and along one side of the fold line 40. The first application of adhesive 62 and 64 is disposed substantially about and near a point 70 along the fold line 40, such that, the first application 62 and 64 is closer to the point 70 along the fold line 40 than to the first side edge 26 and/or the second side edge 28. The point 70 may include a center location along the fold line 40 that is substantially equidistant from the first side edge 26 and the second side edge 28. Additionally, the point 70 along the fold line 40 may include a location along the fold line 40 substantially equidistant from the first end edge 22 and the second end edge 24.

As shown in FIG. 1A, in one configuration of the intermediate form 10 according to the invention, the first application of adhesive includes at least two adhesive spots 26 and 28 disposed adjacent to and along one side of the fold line 40 near the point 70, e.g., a center point, so that at least one adhesive spot 62 and 64 is positioned closer to the point 70 along the fold line 40 than to the first side edge 26 and/or the second side edge 28. In another configuration of the intermediate form 10, each adhesive spot 62 and 64 is positioned closer to the point 70, e.g., a center point, along the fold line 40 than to the first side edge 26 and the second side edge 28.

Each adhesive spot 62 and 64 may include a single spot (line) of adhesive or a pattern of adhesive, as described below. Each adhesive spot 62 and 64 defines a certain configuration, and has a certain length L₁ and L₂ that extends adjacent to and along the fold line 40. The configuration of each adhesive spot 62 and 64, e.g., the length L₁ and L₂, helps to position an outer edge or end 62A and 64A of one or both adhesive spots 62 and 64 closer to the point 70 along the fold line 40 than to the first side edge 26 and/or the second side edge 28.

The adhesive spots 62 and 64 of the first application may have the same or different dimensions, including the same or different length L₁ and L₂. Where the adhesive spots 62 and 64 have the same length L₁ and L₂, the outer edges or ends 62A and 64A of the adhesive spots 62 and 64 may be disposed substantially equidistant from the point 70 along the fold line 40.

In a preferred configuration of the intermediate form 10 according to the invention as shown in FIG. 1A, the adhesive spots 62 and 64 of the first application have the same length L₁ and L₂, and the outer edges or ends 62A and 64A of the adhesives spots 62 and 64 are disposed substantially equidistant from a center point 70 along the fold line 40 and are disposed closer to the center point 70 than to the first side edge 26 and the second side edge 28.

As also shown in FIG. 1A, in one configuration of the intermediate form 10 according to the invention, the first application of adhesive 62 and 64 is located along the first panel or postcard 32, although this does not limit the invention and the first application of adhesive 62 and 64 may be positioned on the opposite side of the fold line 40 along the second panel or postcard 34.

While FIG. 1A illustrates the first application of adhesive includes at least two adhesive spots 62 and 64, which include lines of adhesive 62 and 64 arranged in a substantially linear orientation relative to one another, the invention is not so limited and envisions that the adhesive spots 62 and 62 of the first application may define any shape or any size, such as, for instance, dot-shaped spots, and may be arranged in any orientation relative to one another, such as, for instance, at an offset orientation. Where adhesive spots 62 and 64 include dot-shaped configurations and have certain diameters, an outer edge of each spot diameter farthest from the point 70 along the fold ling 40 is closer to the point 70 than to the first side edge 26 or the second side edge 28.

The intermediate form 10 further includes a second application of adhesive 50 disposed adjacent to at least one end edge 22 and 24. The second application 50 extends adjacent to and along the end edge 22 and 24. In one configuration of the intermediate form 10 according to the invention, the second application of adhesive 50 may be disposed adjacent and substantially parallel to at least a portion of the end edge 22 and 24. In another configuration of the intermediate form 10 according to the invention, the second application of adhesive 50 may be disposed substantially flush with either end edge 22 or 24.

While FIG. 1A illustrates the second application of adhesive 50 includes a single spot (line) of adhesive, the invention is not so limited and envisions that the second application of adhesive 50 may include a pattern of adhesive spots, wherein the adhesive spots define any shape or any size, such as, for instance, dot-shaped spots, and may be arranged in any orientation relative to one another, such as, for instance, in a substantially linear orientation or an offset orientation. In addition, the second application of adhesive 50 may include a single line or spot, or a pattern of lines or spots of adhesive, which extends partially or substantially entirely across the intermediate form 10 adjacent to at least one the first or the second end edges 22 and 24.

As shown in FIG. 1A, in one configuration of the intermediate form 10 according to the invention, the second application of adhesive 50 and the first application of adhesive 62 and 64 are disposed along the first panel or postcard 32. In this arrangement, when the intermediate form 10 folds along the fold line 40, the first and the second applications of adhesive 62, 64 and 50 may adhere to the second panel or postcard 34 to secure the intermediate form 10 in a double postcard configuration.

The first application 62 and 64 or the second application 50 of adhesive may include, but is not limited to, pressure sensitive adhesive, re-moist adhesive, hot or cold melt adhesive, hot or cold melt glue, and/or pressure sensitive cohesive.

Referring to FIGS. 1B-1E, other configurations of the intermediate form 10 according to the invention shown in and described with reference to FIG. 1A are anticipated and illustrated. Features of the configurations of the intermediate form 10 shown in FIGS. 1B-1E that correspond to features of the intermediate form 10 shown in FIG. 1A are indicated by the same reference numbers.

FIG. 1B illustrates another configuration of the intermediate form 10 according to the invention including the features of the intermediate form 10 shown in and described with reference to FIG. 1A and further including a third application of adhesive 66 and 68. The third application of adhesive 66 and 68 is disposed adjacent to and along one side of the fold line 40 opposite to the side of the fold line 40 along which the first application of adhesive 62 and 64 is disposed. The third application of adhesive 66 and 68 is positioned substantially about and near the point 70 along the fold line 40, such that, the third application 66 and 68 is closer to the point 70 along the fold line 40 than to the first side edge 26 and/or the second side edge 28. As mentioned above, the point 70 may include a center location along the fold line 40 that is substantially equidistant from the first side edge 26 and the second side edge 28. Additionally, the point 70 along the fold line 40 may include a location along the fold line 40 substantially equidistant from the first end edge 22 and the second end edge 24.

As shown in FIG. 1B, in one configuration of the intermediate form 10 according to the invention, the third application of adhesive includes at least two adhesive spots 66 and 68 disposed adjacent to and along one side of the fold line 40 near the point 70, e.g., a center point, so that at least one adhesive spot 66 and 68 is positioned closer to the point 70 along the fold line 40 than to the first side edge 26 and/or the second side edge 28. In another configuration of the intermediate form 10, each adhesive spot 66 and 68 is positioned closer to the point 70, e.g., a center point, along the fold line 40 than to the first side edge 26 and the second side edge 28.

Each adhesive spot 66 and 68 may include a single spot (line) of adhesive or a pattern of adhesive, as described below. Each adhesive spot 66 and 68 defines a certain configuration, and has a certain length L₃ and L₄ that extends adjacent to and along the fold line 40. The configuration of each adhesive spot 66 and 68, e.g., the length L₃ and L₄, helps to position an outer edge or end 66A and 68A of one or both adhesive spots 66 and 68 closer to the point 70 along the fold line 40 than to the first side edge 26 and/or the second side edge 28.

The adhesive spots 66 and 68 may have the same or different dimensions, including the same or different length L₃ and L₄. Where the adhesive spots 66 and 68 have the same length L₃ and L₄, the outer edges or ends 66A and 68A of the adhesive spots 66 and 68 may be disposed substantially equidistant from the point 70 along the fold line 40.

In a preferred configuration of the intermediate form 10 according to the invention shown in FIG. 1B, the adhesive spots of the third application have the same length L₃ and L₄, and the outer edges or ends 66A and 68A of the adhesives spots 66 and 68 are disposed substantially equidistant from the center point 70 along the fold line 40 and are disposed closer to the center point 70 than to the first side edge 26 and the second side edge 28.

While FIG. 1B illustrates the third application of adhesive includes at least two adhesive spots 66 and 68, which include lines of adhesive 66 and 68 arranged in a substantially linear orientation relative to one another, the invention is not so limited and envisions that the adhesive spots 66 and 68 of the third application may define any shape or any size, such as, for instance, dot-shaped spots, and may be arranged in any orientation relative to one another, such as, for instance, at an offset orientation. Where adhesive spots 66 and 68 include dot-shaped configurations and have certain diameters, an outer edge of each spot diameter farthest from the point 70 along the fold ling 40 is closer to the point 70 than to the first side edge 26 or the second side edge 28.

As shown in FIG. 1B, in one configuration of the intermediate form 100 according to the invention, the third application of adhesive 66 and 68 is disposed along the second panel or postcard 34 and the first application of adhesive 62 and 64 is disposed along the first panel or postcard 32. The third application of adhesive 66 and 68 may be positioned substantially opposite to the first application of adhesive 62 and 64. The adhesive spots 62 and 64 of the first application may have the same or different dimensions than the adhesive spots 66 and 68 of the third application of adhesive.

In one configuration, the third application of adhesive 66 and 68 may be further positioned opposite to the first application of adhesive 62 and 64, such that, at least a portion of at least one spot 66 or 68 of the third application is substantially opposite to at least a portion of at least one spot 62 or 64 of the first application. In this arrangement, when the intermediate form 10 folds along the fold line 40 to form the double postcard, at least a portion of the at least one adhesive spot 66 or 68 of the third application may contact at least a portion of the at least one adhesive spot 62 or 64 of the first application. In this configuration, the first application 62 and 64 and the third application 66 and 68 of adhesive may preferably include applications of pressure sensitive cohesive.

In addition, in one configuration of the intermediate form 10 according to the invention, as shown in FIG. 1B, the length L₁ and L₂ of the adhesive spots 62 and 64 of the first application may be substantially the same length as the length L₃ and L₄ of the adhesive spots 66 and 68 of the third application. In this configuration, at least a portion of the adhesive spots 62 and 64 of the first application contact at least a portion of the opposite adhesive spots 66 and 68 of the third application when the intermediate form 10 folds along the fold line 40.

Further, the first application of adhesive 62 and 64 and the third application of adhesive 66 and 68 may include complementary adhesive patterns, including the adhesive spots 62, 64 and 66, 68 of each application arranged in the same orientation relative to one another. The adhesive spots 62, 64 and 66, 68 of each application, optionally, may further include the same shapes and/or may define the same dimensions. In this configuration and arrangement, the first application 62 and 64 and the third application 66 and 68 may preferably include complementary pressure sensitive cohesive.

In a preferred configuration of the intermediate form 10 according to the invention shown in FIG. 1B, the first and the third applications of adhesive 62, 64 and 66, 68 include complementary patterns of pressure sensitive cohesive. The patterns include the adhesive spots 62 and 64 of the first application and the adhesive dots 66 and 68 of the third application having the same configurations and the same lengths L₁, L₂ and L₃, L₄, with complementary adhesive spots 62, 64 and 66, 68 disposed substantially opposite one another on each side of the fold line. The outer edges or ends of each adhesive spot 62A, 64A and 66A, 68A are closer to the center point 70 along the fold line 40 than to the first side edge 26 and the second side edge 28.

The invention is not limited to the configuration and the arrangement of the first 62, 64 and the third 66, 68 applications of adhesive shown in FIG. 1B and anticipates that the first 62, 64 and the third 66, 68 applications may be arranged in an offset orientation relative to one another on each side of the fold line 40. In such a configuration of the intermediate form 10 according to the invention, the first application 62 and 64 and the third application 66 and 68 may preferably include applications of pressure sensitive adhesive, re-moist adhesive, hot or cold melt adhesive and/or hot or cold melt glue.

The intermediate form 10 of FIG. 1B may optionally include a fourth application of adhesive 52 disposed adjacent to at least one end edge 22 and 24 and extending along at least a portion of the end edge 22 and 24. In one configuration of the intermediate form 10 according to the invention, the fourth application of adhesive 52 may be disposed substantially parallel to at least a portion of the end edge 22 and 24.

While FIG. 1B illustrates the fourth application of adhesive 52 includes a single spot (line) of adhesive, the invention is not so limited and envisions that the fourth application of adhesive 52 may include a pattern of adhesive spots, wherein the adhesive spots define any shape or any size, such as, for instance, dot-shaped spots, and may be arranged in any orientation relative to one another, such as, for instance, in a substantially linear orientation or an offset orientation. In addition, the fourth application of adhesive 52 may include a single line or spot, or a pattern of lines or spots, which extends partially or substantially across the intermediate form 10 adjacent to at least one of the first and the second end edges 22 and 24.

As shown in FIG. 1B, in one configuration of the intermediate form 10 according to the invention, the second and the fourth applications of adhesive 50 and 52 are disposed along the first end edge 22 and the second end edge 24, respectively. In this configuration, when the intermediate form 10 folds along the fold line 40, at least a portion of the second application of adhesive 50 contacts at least a portion of the fourth application of adhesive 52 to help to secure the folded intermediate form 10 in a double postcard configuration. In this case, the second and the third applications of adhesive 50, 52 may preferably include applications of pressure sensitive cohesive.

Referring to FIG. 1C, the intermediate form 10 according to the invention shown in FIG. 1A may further include at least one line of weakness 42 or 44 adjacent to and along at least the first or the second end edges 22 and 24. The intermediate form 10 of FIG. 1C may include a first line of weakness 42 adjacent and substantially parallel to the first end edge 22 and may further include a second line of weakness 44 adjacent and substantially parallel to the second end edge 24.

In one configuration of this intermediate form 10 according to the invention, the second application of adhesive 50 may be disposed along a marginal strip 42A defined by the first line of weakness 42 and the first end edge 22, or along a marginal strip 44A defined by the second line of weakness 44 and the second end edge 24. In this configuration of the intermediate form 10, the first and the second lines of weakness 42 and 44 are coincident with one another when the intermediate form 10 folds along the fold line 40 to form a double postcard. The second application of adhesive 50 in this case would adhere along the opposing marginal strip 42A or 44A, and may preferably include pressure sensitive adhesive, re-moist adhesive, hot or cold melt adhesive and/or hot or cold melt glue.

The marginal strips 42A and 44A are disposed and configured, such that, when the intermediate form 10 folds to the double postcard configuration an end-user may tear the double postcard along the coincident lines of weakness 42 and 44 to remove the marginal strips 42A and 44A. The second application of adhesive 50 is thereby removed from the double postcard and removal of the adhesive 50, which permits the end-user to open the double postcard.

Referring to FIG. 1D, the intermediate form 10 according to the invention shown in FIG. 1B may also include at least one line of weakness 42 or 44 adjacent to and along at least the first or the second end edges 22 and 24. The intermediate form 10 of FIG. 1D may include a first line of weakness 42 adjacent and substantially parallel to the first end edge 22, and may further include a second line of weakness 44 adjacent and substantially parallel to the second end edge 24.

In one configuration of this intermediate form 10 according to the invention, the second application of adhesive 50 may be disposed along the marginal strip 42A defined by the first line of weakness 42 and the first end edge 22, and the fourth application of adhesive 52 may be disposed along a marginal strip 44A defined by the second line of weakness 44 and the second end edge 24. In this configuration of the intermediate form 10, the first and the second lines of weakness 42 and 44 are coincident with one another when the intermediate form 10 folds along the fold line 40 to form a double postcard. At least a portion of the second application of adhesive 50 in this case would adhere to at least a portion of the fourth application of adhesive 52, and the applications of adhesive 50 and 52 may preferably include pressure sensitive cohesive.

Referring to FIG. 1E, the intermediate form 10 shown in FIG. 1D is illustrated including the second 50 and the fourth 52 applications of adhesive disposed along the intermediate form 10 in a pattern of adhesive lines or spots. As described above with reference to FIGS. 1A and 1B, the second 50 application and/or the fourth 52 application of adhesive may include a single adhesive line or spot or may include a pattern of adhesive lines or spots. The adhesive lines/spots may have any shape or any size, and such lines/spots may be arranged in any orientation relative to one another. In addition, the second 50 and the fourth 52 applications may include a single line or spot or a pattern of lines or spots that extends partially or substantially entirely across the intermediate form 10 adjacent to the first and/or the second end edges 22 and 24.

The second 50 and the fourth 52 applications of adhesive also may be disposed and configured, such that, at least a portion of the adhesive line or spot of the second 50 application of adhesive contacts at least a portion of the adhesive line or spot of the fourth 52 application of adhesive. Further, the second 50 and the fourth 52 applications of adhesive may include complementary adhesive lines or patterns of adhesive, such that, when the intermediate form 10 folds, at least a portion of an adhesive line or pattern of one application of adhesive contacts at least a portion of an adhesive line or pattern of the other opposing application of adhesive. Those of ordinary skill in the art can appreciate that the second 50 and the fourth 52 applications of adhesive may include any configuration of adhesive lines/spots and any arrangement of adhesive lines/spots.

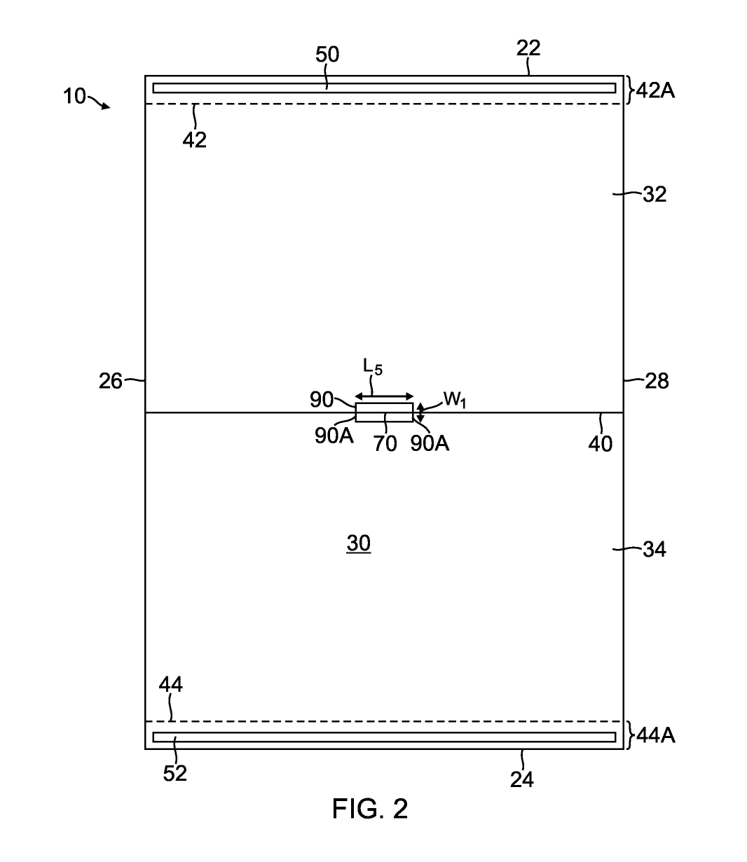

Referring to FIG. 2, in another aspect, the invention provides a double postcard intermediate form 10 designed and configured to fold to a double postcard, as described in detail below with reference to FIGS. 5A-5B and 6A-6B. The intermediate form 10 of FIG. 2 folds to a double postcard configuration having dimensions that qualifies for postcard postal rates and sealing features that comply with U.S. Postal Service standards. The intermediate form 10 includes the first face 30 and the second face (not shown in FIG. 2), the first and the second end edges 22 and 24, the first and the second side edges 26 and 28, and the fold line 40 as are shown in and described with reference to FIG. 1A.

The intermediate form 10 of FIG. 2 is similar to the intermediate form 10 shown in and described with reference to any of FIGS. 1A-1E with the exception of a first application of adhesive 90. The first application of adhesive 90 is disposed substantially on and about a point 70 along the fold line 40 and is positioned closer to the point 70 than to the first side edge 26 and/or the second side edge 28. As shown in FIG. 2, the first application of adhesive 90 is also disposed on and about a portion of the fold line 90.

In one configuration of the intermediate form according to the invention 10, the adhesive spot 90 has a configuration and a length L₅ and a width W₁ that configures the adhesive spot 90 on and about the point 70 along the fold line 40. The adhesive spot 90 is configured, such that, at least one outer edge or end 90A of the adhesive spot 90 is positioned closer to the point 70 along the fold line 40 than to the first side edge 26 and/or the second side edge 28. As mentioned, the point 70 along the fold line may include a center point positioned substantially equidistant from the first and the second side edges 26 and 28. Additionally, the point 70 may include a position along the fold line 40 substantially equidistant from the first and the second end edges 22 and 24.

In a preferred configuration of the intermediate form 10 according to the invention shown in FIG. 2, the point 70 includes a center point along the fold line 40 and the adhesive spot 90 of the first application is disposed on and about the center point 70. The adhesive spot 90 is configured and includes a length L₅ and width W₁ that configures the adhesive spot 90, such that, the outer edges and ends 90A of the adhesive spot 90 are closer to the center point 70 than to the first side edge 26 and/or the second side edge 28.

The first application of adhesive 90 may include a single adhesive spot having any shape and size. The length L₅ and width W₁ may configure the adhesive spot 90, such that, substantially equal portions of the adhesive spot 90 are disposed on each side of the fold line 40, although the invention is not limited in this respect. In addition, the length L₅ and width W₁ may configure the adhesive spot 90, such that, the center point 70 is positioned substantially at a center of the adhesive spot 90.

In other configurations of the intermediate form 10, the adhesive spot 90 may include a dot-shaped adhesive spot, such that, an outer diameter edge of the dot-shaped spot 90 is closer to the center point 70 along the fold line 40 than to the first side edge 26 and/or the second side edge 28.

The position of the first application of adhesive 90 helps to secure the intermediate form 10 in a folded configuration when the intermediate form 10 folds to the double postcard, and helps to retain the double postcard in a closed and/or sealed condition during processing and mailing. In addition, the first application of adhesive 90 is disposed and is configured to help to prevent or reduce puckering along and/or about the fold line 40, when the intermediate form 10 folds to the double postcard. Such puckering can occur during processing and/or folding of the intermediate form 10.

Optionally, the intermediate form 10 shown in FIG. 2 further includes the second application of adhesive 50 and/or the fourth application of adhesive 52 as described above. In addition, the intermediate form 10 shown in FIG. 2 may also optionally include the first and/or the second line of weakness 42 and 44 as described above.

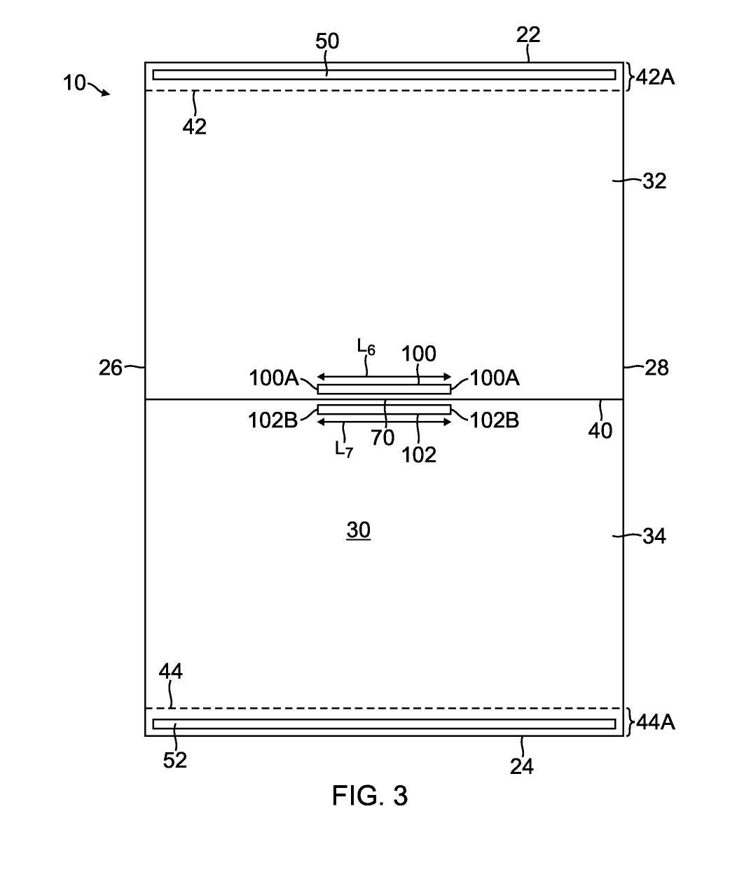

Referring to FIG. 3, in another aspect, the invention provides a double postcard intermediate form 10 designed and configured to fold to a double postcard, as described in detail below with reference to FIGS. 5A-5B and 6A-6B. The intermediate form 10 of FIG. 3 is similar to the form 10 shown in and described with reference to FIG. 2 with the exception of a first application of adhesive 100 and 102.

The first application of adhesive includes at least two adhesive spots 100 and 102 positioned adjacent to and along each side of the fold line 40, such that, the fold line 40 is disposed between the two adhesive spots 100 and 102. The adhesive spots 100 and 102 are disposed closer to the point 70 along the fold line 40 than to the first side edge 26 and/or the second side edge 28. As described above, the point 70 along the fold line 40 may include a center position along the fold line 40 that is substantially equidistant from the first and the second side edges 26 and 28. Additionally, the point 70 may include a position along the fold line 40 that is substantially equidistant from the first and the second end edges 22 and 24.

Each adhesive spot 100 and 102 may include a single spot (line) of adhesive or a pattern of adhesive, as described below. Each adhesive spot 100 and 102 defines a certain configuration, and has a certain length L₆ and L₇ that extends adjacent to and along the fold line 40. The configuration of each adhesive spot 100 and 102, such as the length L₆ and L₇ of each adhesive spot 100 and 102, helps to position at least one outer edge or end 100A of one adhesive spot 100 and at least one outer edge or end 102B of the other adhesive spot 102 closer to the point 70, e.g., a center point, along the fold line 40 than to the first side edge 26 and/or the second side edge 28.

The adhesive spots 100 and 102 may have the same or different dimensions, including the same or different length L₆ and L₇. Where the adhesive spots 100 and 102 have the same length L₆ and L₇, the outer edges or ends 100A and 102B of the adhesive spots 100 and 102 may be disposed substantially equidistant from the point 70, e.g., a center point, along the fold line 40.

While FIG. 3 illustrates the first application of adhesive includes at least two adhesive spots 100 and 102, which include lines of adhesive 100 and 102, the invention is not so limited and envisions that the adhesive spots 100 and 102 may define any shape or any size, such as, for instance, dot-shaped spots, and may be arranged in any orientation relative to one another, such as, for instance, at an offset orientation or a substantially parallel orientation. Where adhesive spots 100 and 102 include dot-shaped configurations and have certain diameters, an outer edge of each spot diameter farthest from the point 70 along the fold ling 40 is closer to the point 70 than to the first side edge 26 or the second side edge 28. In addition, the adhesive spots 100 and 102 may be disposed substantially parallel to the fold line 40.

In the preferred configuration of the intermediate form 10 according to the invention shown in FIG. 3, the adhesive spots 100 and 102 of the first application include single lines of adhesive having the same length L₆ and L₇ and with at least one end 100A and 102B positioned closer to the center point 70 along the fold line 40 than to the first side edge 26 and the second side edge 28. Further, the adhesives spots 100 and 102 are positioned substantially parallel to the fold line 40 and are substantially equidistant from the fold line 40. In this configuration of the intermediate form 10, the adhesive spots 100 and 102 may preferably include pressure sensitive cohesive.

The first application of adhesive 100 and 102 helps to secure the intermediate form 10 in a folded configuration when the intermediate form 10 folds to the double postcard, and helps to prevent or reduce puckering along and/or about the fold line 40.

Optionally, the intermediate form 10 shown in FIG. 3 further includes the second application of adhesive 50 and/or the fourth application of adhesive 52 as described above. In addition, the intermediate form 10 shown in FIG. 3 may also optionally include the first and/or the second line of weakness 42 and 44 as described above.

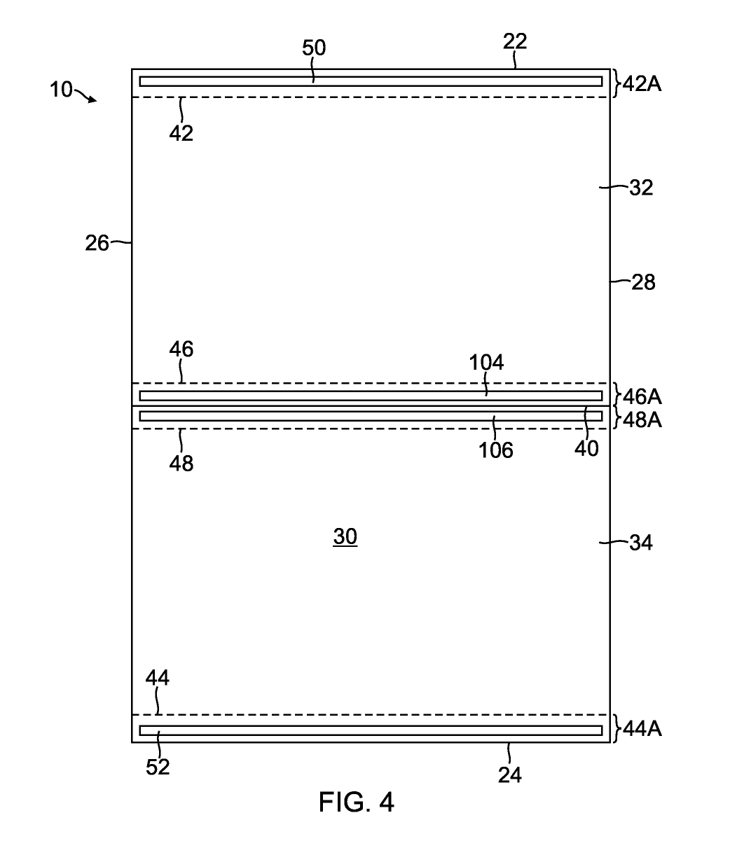

Referring to FIG. 4, in a further aspect, the invention provides a double postcard intermediate form 10 designed and configured to fold to a double postcard, as described in detail below with reference to FIGS. 5A-5B and 6A-6B. The intermediate form 10 of FIG. 4 is similar to the intermediate 10 shown in and described with reference to FIG. 3 with the exception of the first application of adhesive 104 and 106. The first application of adhesive includes at least two adhesive spots 104 and 106 positioned adjacent to and along each side of the fold line 40, such that, the fold line 40 is disposed between the two adhesive spots 104 and 106.

Each adhesive spot 104 and 106 defines a length L₈ and L₉. The length L₆ and L₇ of each adhesive spot 104 and 106 extends traversely along at least a portion of the intermediate form 10 between the first and the second side edges 26 and 28. The adhesive spots 104 and 106 may have the same or different shapes and dimensions, and, in particular, may have the same or different lengths L₈ and L₉. In one configuration of the intermediate form 10 shown in FIG. 4, the length L₈ and L₉ of one or both adhesive spots 104 and 106 may extend traversely along a substantial portion of the intermediate form 10 between the first and the second side edges 26 and 28. In addition, one or both adhesives spots 104 and 106 may be positioned substantially parallel to the fold line 40. Further, the adhesive spots 104 and 106 may be positioned substantially equidistant from the fold line 40.

Each adhesive spot 104 and 106 may include a single line or spot or a pattern of lines or spots having the respective length L₈ and L₉, and may be arranged in any configuration relative to one another across the fold line 40, such as, for instance, in an offset orientation or in a substantially parallel orientation.

In a preferred configuration of the intermediate form 10 shown in FIG. 4, the lengths L₈ and L₉ of the adhesive spots 104 and 106 are substantially the same and extend across most of the area of the intermediate form 10 between the first and the second side edges 26 and 28. The adhesive spots 104 and 106 have the same shape, and may include single lines of adhesive or patterns of lines or spots of adhesive. The adhesive spots 104 and 106 are substantially parallel to one another and to the fold line 40, and are equidistant from the fold line 40. The first application of adhesive 104 and 106 may preferably include pressure sensitive cohesive.

The intermediate form 10 of FIG. 4 may optionally include one or more lines of weakness 46 and 48 extending traversely between the first side edge 26 and the second side edge 28. In one configuration, a first line of weakness 46 and the fold line 40 define a marginal strip 46A along which one of the adhesive spots 104 is positioned, and a second line of weakness 48 and the fold line 40 define a second marginal strip 48A along which the other adhesive spot 106 is positioned. The lines of weakness 46 and 48 may be coincident, such that, where the intermediate form 10 is folded in the double postcard configuration, an end-user may tear the form 10 along the coincident lines of weakness 46 and 48, which removes the adhesive spots 104 and 106 and thereby enables the end-user to open the double postcard.

Optionally, the intermediate form 10 shown in FIG. 4 further includes the second application of adhesive 50 and/or the fourth application of adhesive 52 as described above. In addition, the intermediate form 10 shown in FIG. 4 may also optionally include the first and/or the second line of weakness 42 and 44 as described above.

Referring to FIGS. 5A and 5B, any of the configurations of the intermediate form 10 according to the invention shown in and described above with reference to FIGS. 1A-4 may be folded along the fold line 40 to the double postcard configuration according to the invention. FIG. 5A illustrates the intermediate form 10, in any configuration, in a folding orientation, and FIG. 5B illustrates the intermediate form 10 in a folded condition as a double postcard 12.

The intermediate form 10 is V-folded along the fold line 40, as shown by arrow 80 in FIG. 5A, to define the double postcard 12, as shown in FIG. 5B. The resulting double postcard 12 has dimensions that satisfy U.S. Postal Service rates for postcards. In addition, the double postcard 12 enables inspection of the inner surfaces of the double postcard 12 that result when the first face 30 of the first panel or postcard 32 and the first face 30 of the second panel or postcard 34 are disposed in face-to-face relation as a result of the intermediate form 10 folding along the fold line 40. Without applications of adhesive/cohesive along the longitudinal first and second side edges 26 and 28, the intermediate form 10, in its folded condition, meets U.S. Postal Service sealing standards and permits separation of the side edges 26 and 28, as shown by arrow 82 in FIG. 5B, to thereby enable inspection of the inner surfaces of the double postcard 12.

As shown in FIGS. 5A and 5B, the first face 30 of the second panel or postcard 34 includes return addressee information 36 and any other variable or non-variable information or indicia 37 required or permitted, such as metered postage. The second face 31 of the first panel or postcard 32 includes outgoing addressee information 38 and any other variable or non-variable information or indicia 39 required or permitted. The fold line 40, as described above, may be configured to enable the first panel or postcard 32 and the second panel or postcard 34 to detach and separate from one another when an end-user opens the double postcard 12. The detached second panel or postcard 34 may serve as a reply or return postcard 34 for any of a variety of purposes. As discussed above, when detached from the first panel or postcard 32, the second panel or the reply or return postcard 34 has overall dimensions that satisfy requirements for postcard postal rates.

In addition, the first face 30 of the first panel or postcard 32 may include any other variable or non-variable information, e.g., advertising, that is permitted. Further, the second face 31 of the second panel or postcard 34 (not shown) includes any other variable or non-variable information that is permitted on a return or reply postcard 34 and may relate to the purpose of the return or reply postcard 34.

The positions and configurations of the first applications of adhesive/cohesive along the intermediate form 10 as shown in and described above with reference to FIGS. 1A-4 help to maximize the area along the first face 30 and the second face 31 of the first and second panels 32 and 34 available to receive outgoing and return addressee information and any other information or indicia that is permitted and desired along the double postcard 12.

In addition, the positions and configurations of the first applications of adhesive/cohesive help to secure and to retain the intermediate form 10 in the folded condition as the double postcard 12, and further help to eliminate or to at least reduce the incidence of damage or tearing, or “fiber tear,” along the double postcard 12, particularly along the side edges 26 and 28, during processing and/or during mailing and sorting with postal equipment. The positions and configurations of the first applications of adhesive/cohesive also help to eliminate or reduce damage or fiber tear when an end-user opens the double postcard 12. Elimination or reduction of damage or fiber tear along the double postcard 12 helps to ensure that the reply or return postcard 34, when detached from the first panel or postcard 32, is tear-free, or at least has little tearing, such that, the reply or return postcard 34 has rigidity and thereby stability during return mailing and processing.

Referring to FIGS. 6A and 6B, an alternative configuration of the intermediate 10 shown in FIGS. 5A and 5B is shown. In this configuration, the return addressee information 36 and any other variable or non-variable information or indicia required or permitted are displayed along the first face 30 of the first panel or postcard 32 rather than along the first face 30 of the second panel or postcard 34, as shown in FIG. 5A. Consequently, the outgoing addressee information 38 and any other variable or non-variable information or indicia required or permitted are displayed along the second face 31 of the second panel or postcard 34 rather than along the second face 31 of the first panel or postcard 34.

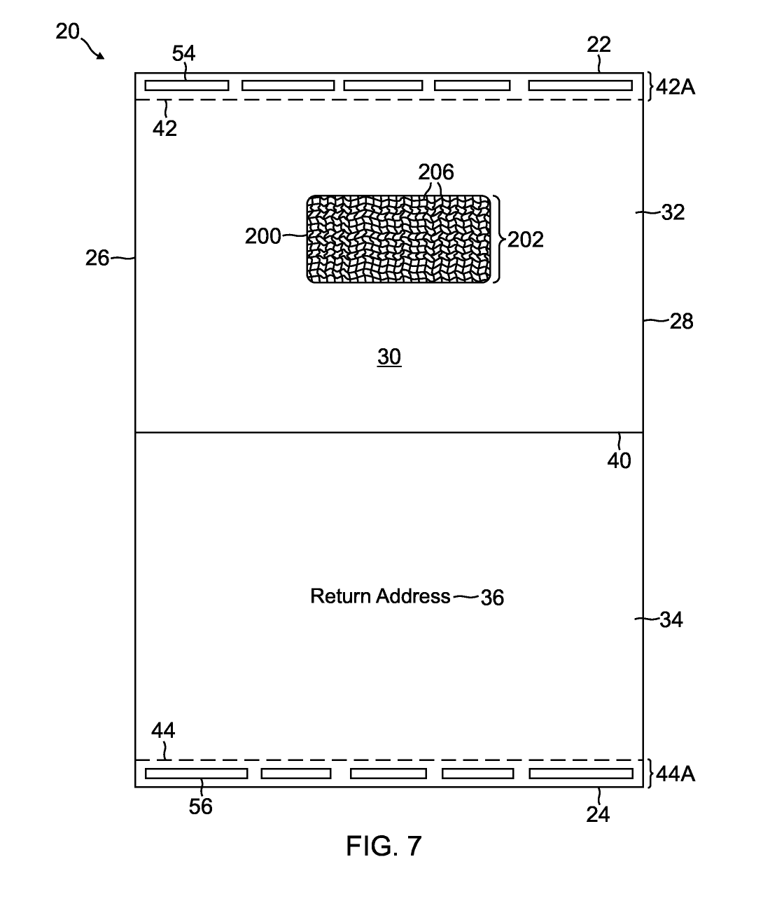

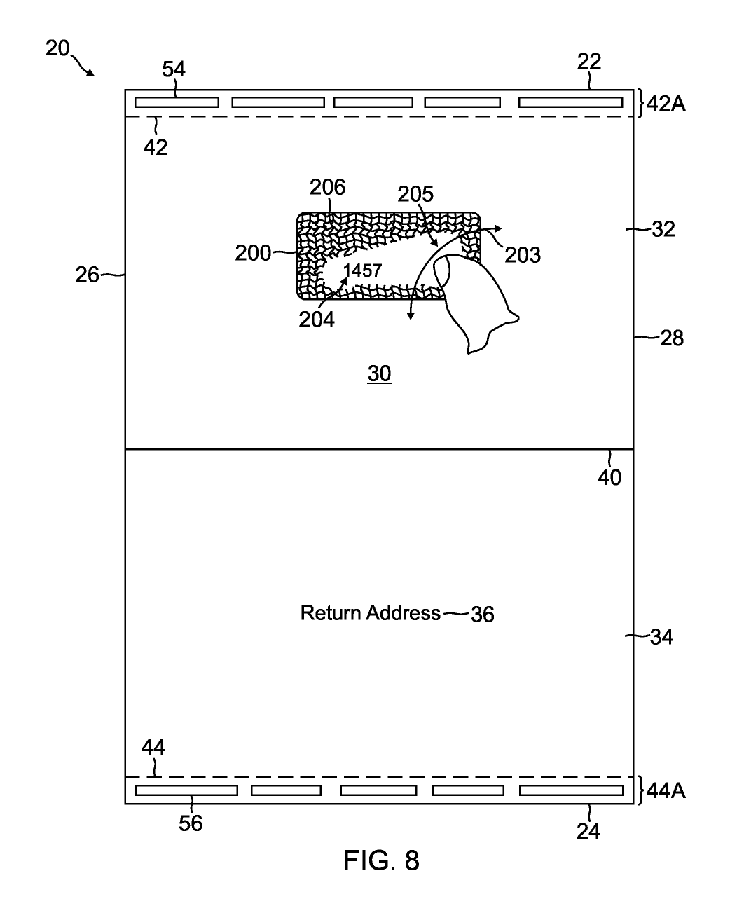

Referring to FIGS. 7 and 8, in another aspect, the invention provides an intermediate form 20 designed and configured to fold to a double postcard having postcard dimensions that satisfy U.S. Postal Service requirements for postcard postal rates. The intermediate form 20 includes the fold line 40 that defines at least a first panel 32 and at least a second panel 34.

The intermediate form 20 further includes one or more security features 200 configured with one or more thermochromic inks 206. Each security feature 200 may be configured and disposed along the intermediate form 20 over and/or under private or sensitive information or indicia printed, imaged or otherwise applied along either face of the intermediate form 20, such that, the security feature 200 helps to substantially conceal such information and indicia, e.g., substantially cover such information and indicia so that the information and indicia are not readily visible, e.g., to the human eye. Alternatively, each security feature 200 may be configured and disposed over and/or under private or sensitive information or indicia, such that, the security feature 200 helps to hide or helps to camouflage such information and indicia, e.g., helps to prevent recognition of such information and indicia, e.g., with the human eye. Those of ordinary skill in the art will appreciate that the degree or the extent to which the one or more security features 200 of the intermediate form 20 according to the invention help to substantially conceal or help to hide or camouflage private or sensitive information and indicia along the form 20 includes a range of visibility or recognition of the information and indicia applied under and/or over the one or more security features. For purposes of disclosing the invention only, the security feature 200 may be configured and disposed along the intermediate form 20 to help to substantially conceal private or sensitive information or indicia, as described above, or may be configured and disposed to help to hide or to help to camouflage such information or indicia, as also described above; however, the invention is not so limited and envisions that the intermediate form 20 with the one or more security features 200 can include any of a variety of configurations of the security feature(s) 200 that may provide a range of coverage of the private or sensitive information or indicia along the intermediate form 20.

Such private or sensitive information and indicia may include, but are not limited to, confidential, secret, personal, restricted, classified, and other information or indicia for non-public and/or authorized use and distribution. For instance, such information and indicia may include personal identification numbers (PINs), bank account numbers, credit card account numbers, passwords, authorization numbers, sweepstakes information, and any other information or indicia that are restricted with respect to knowledge, use, and/or distribution by one or more intended recipients and/or authorized end-users.

While the intermediate form 20 shown in FIG. 7 includes one of a variety of configurations of the intermediate form 20 according to the invention, one of ordinary skill in the art will appreciate that the security feature 200 described below may be included along any intermediate form that folds to a double postcard, as well as may be included along any of the intermediate forms 10 and double postcards 12 shown in and described above with reference to FIGS. 1A-6B. As shown in FIG. 7, features of the configuration of the intermediate form 20 that correspond to features of the intermediate forms 10 and double postcards 12 shown in FIGS. 1A-6B are indicated by the same reference numbers.

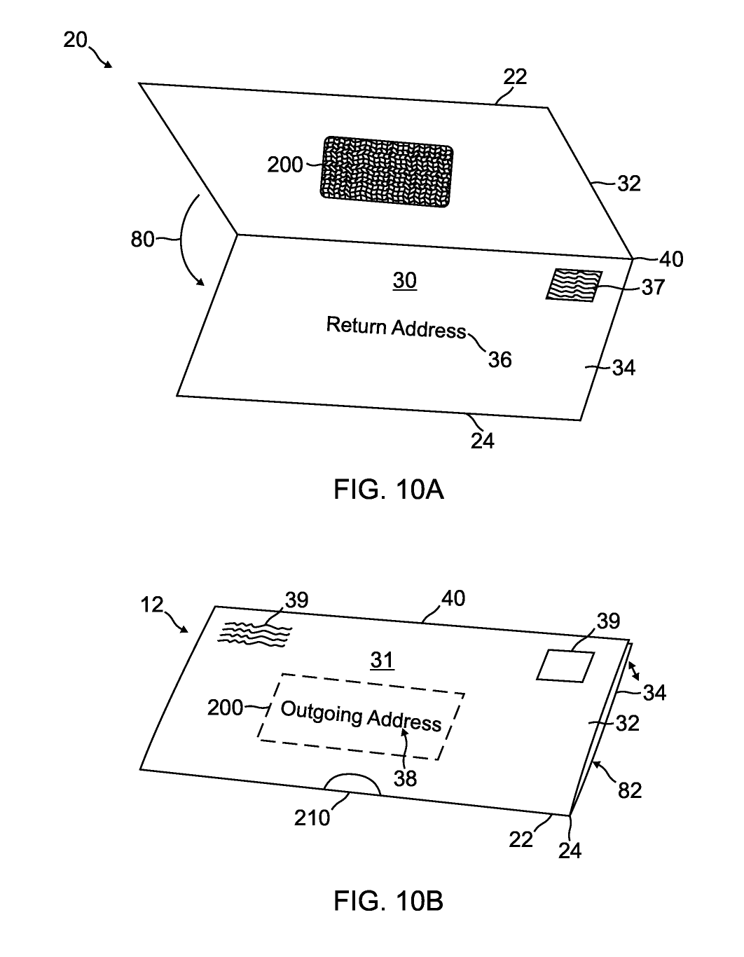

FIG. 7 illustrates one configuration of the intermediate form 20 including one or more security features 200 according to the invention disposed along one face of the intermediate form 20. The at least one security feature 200 would be disposed along an inner face when the intermediate form 20 folds along the fold line 40 to the double postcard configuration 12. In one configuration, the security feature 200 is disposed along the first face 30 of the first panel or postcard 32 and thereby would be disposed along an inner face of the double postcard configuration 12 as is shown below in FIGS. 10A and 10B. Alternatively, the security feature 200 may be disposed along the first face 30 of the second panel or postcard 34 and thereby would be disposed in face-to-face relation with the first face 30 of the first panel or postcard 34 when the intermediate form 20 folds along the fold line 40 to the double postcard 12.

The security feature 200 includes one or more thermochromic inks 206 printed, imaged or otherwise applied along either panel 32 or 34 within at least a portion of a given “block-out” area 202. The block-out area 202 has dimensions sufficient to include within a perimeter of the area 202 at least a portion of specific private or sensitive information or indicia printed, imaged or otherwise applied along the intermediate form 20. The one or more thermochromic inks 206 may include one or more inks of one color or of different colors to help to configure the security feature 200 with a required or desired amount of ink or density, e.g., coverage, along at least a portion of the block-out area 202, such that, at least a portion of the private or sensitive information or indicia applied under and/or over the security feature 200 are covered and/or hidden by the thermochromic ink(s) 206 to the degree or the extent as is required or desired for such application.

The thermochromic ink(s) 206 employed to configure the security feature 200 along the intermediate form 20 according to the invention preferably include thermochromic inks(s) that temporarily change color(s) in response to changes in temperatures, such as, for instance, in response to increases in temperatures. Such temporary color changes of the thermochromic ink(s) 206, e.g., in response to temperature increases, permit private or sensitive information or indicia under and/or over the security feature 200 to become temporarily and at least partially visible, e.g., to the human eye. As a result, an intended recipient and/or authorized end-user of the intermediate form 20 according to the invention would be able to discern at least a portion of the private or sensitive information or indicia. As temperatures of the thermochromic ink(s) 206 return to temperatures other than those temperatures that help to cause color changes, the thermochromic ink(s) 206 at least partially recover and at least partially return to color(s) displayed before the occurrence of the color changes. In this manner, the security feature 200 at least partially recovers and thereby at least partially covers the private or sensitive information or indicia.

The security feature 200 may be configured with one or more thermochromic inks 206 printed, imaged or otherwise applied as a pattern, e.g., of large font letters, numbers and/or other shapes/configurations, or as a substantially uniform, consistent or solid application. In addition, the security feature 200 may be configured with one or more layers of thermochromic ink(s) 206. The thermochromic ink(s) 206 may be printed, imaged or otherwise applied along the intermediate form 20 in a given amount or at a given density of the thermochromic ink(s) 206 to help to produce the security feature 200 with a required or desired degree or extent to which the security feature 200 covers or hides the private or sensitive information or indicia. Such security feature 200 may be printed, imaged or otherwise applied along the intermediate form 20 with from less than about 5% thermochromic ink(s) 206 to about 100% thermochromic ink(s) 206.

In one configuration of the intermediate form 20 with at least one security feature 200 according to the invention, the security feature 200 is preferably configured with a combination of black and grey thermochromic inks 206 applied to the intermediate form 20 in a pattern, e.g., of letters, numbers and/or other shapes/configurations, with private or sensitive information or indicia applied under and/or over the security feature 200.

In another configuration of the intermediate form 20 with at least one security feature 200 according to the invention, the security feature 200 is created via printing, imaging or otherwise applying the thermochromic ink(s) 206 along, e.g., at least a portion of a given block-out area 202, of the intermediate form 20. The intermediate form 20 subsequently receives at least a portion of the private or sensitive information or indicia over the security feature 200 via printing, imaging or otherwise applying such information or indicia over at least a portion of the security feature 200.

Alternatively, or additionally, in a further configuration of the intermediate form 20 with at least one security feature 200 according to the invention, the intermediate form 20 receives at least a portion of the private or sensitive information or indicia via printing, imaging or otherwise applying such information or indicia, e.g., within a given block-out area 202, along the intermediate form 20. The intermediate form 20 subsequently receives the thermochromic ink(s) 206 via printing, imaging or otherwise applying the thermochromic ink(s) over at least a portion of the private or sensitive information or indicia, e.g., within the block-out area 202.

In any of these configurations of the intermediate form 20 according to the invention, a portion of the private or sensitive information or indicia may be disposed under the security feature 200 and another portion of the information or indicia may be disposed over the security feature 200. In addition, in any of these configurations of the intermediate form 20 according to the invention, the block-out area 202 may be wholly or partially covered with the thermochromic ink(s) 206.

As mentioned and shown in FIG. 8, the security feature 200 is configured with one or more thermochromic ink(s) 206 formulated to permit the thermochromic ink(s) to temporarily change color(s) in response to changes in temperatures, e.g., increases in temperature or exposure to heat. The security feature 200 may be exposed to temperature changes through any of a variety of options. For instance, techniques to increase temperatures of or to apply heat to at least a portion of the security feature 200 include, but are not limited to, rubbing the security feature 200, breathing on the security feature 200, applying heat to the security feature 200 using a conventional blow dryer or other device, as well as other options sufficient for increasing temperatures of the thermochromic ink(s) 206 of the security feature 200, such that, private or sensitive information or indicia under and/or over the security feature 200 may become temporarily and at least partially visible, e.g., to the human eye.

FIG. 8 illustrates one configuration of the intermediate form 20 including at least one security feature 200 according to the invention configured so that as an end-user rubs the security feature 200 with their finger, e.g., as shown by arrow 203, such rubbing helps to increase temperatures of the thermochromic ink(s) 206. Such temperature increases thereby help to affect color change(s) 205, e.g., thermal color changes, of the thermochromic ink(s) 206 that enable private or sensitive information or indicia, such as, for instance, a personal identification number (PIN) 204, printed, imaged or otherwise applied under and/or over the security feature 200 to become temporarily and at least partially discernible or visible, e.g., to the human eye. The end-user may thereby decipher the PIN number. When rubbing is withdrawn, temperatures of the thermochromic ink(s) 206 return eventually to temperatures that restore at least partially the color(s) of the thermochromic ink(s) 206, which the security feature 200 displays before such temperature changes occur. In this manner, the security feature 200 of the intermediate form 20 according to the invention may be inspected by U.S. Postal Service personnel without comprising the security of any private or sensitive information or indicia. Postal service inspection of the inner surfaces of the intermediate form 20 and the security feature 200 is facilitated along the open side edges 26 and 28 of the intermediate form 20, when the intermediate form 20 folds to a double postcard mailer.

Thermochromic ink(s) suitable for forming the at least one security feature 200 of the intermediate form 20 according to the invention include, but are not limited to, thermochromic inks or thermochromic leuco dyes, such as those available from CTI of Colorado Springs, Colo. and SICPA of Springfield, Va.

As shown in FIGS. 7 and 8 the intermediate form 20 according to the invention may include one or more applications of adhesive 54 and 56 adjacent to and along at least a portion of one or both end edge 22 and 24. While FIGS. 7 and 8 show that the one or more applications of adhesive 54 and 56 include a pattern of adhesive spots 54′ and 56′, with spots of each pattern arranged in a substantially linear orientation relative to one another, the invention is not so limited and anticipates that the applications of adhesive 54 and 56 may include a single adhesive spot, e.g., a linear line of adhesive, or a pattern of adhesive spots, e.g., with adhesive spots arranged in any orientation relative to one another. In addition, the one or more applications of adhesive 54 and 56 may define applications of adhesive equivalent to the second and the fourth applications of adhesive 50 and 52 as are shown in and described above with reference to FIGS. 1A-4.

The one or more applications of adhesive 54 and 56 may include, but are not limited to, pressure sensitive adhesive, re-moist adhesive, hot or cold melt adhesive, hot or cold melt glue, and/or pressure sensitive cohesive.

In addition, the intermediate form 20 shown in FIGS. 7 and 8 may optionally include one or both lines of weakness 42 and 44, as described above, which define the marginal portions 42A and 44A, respectively.

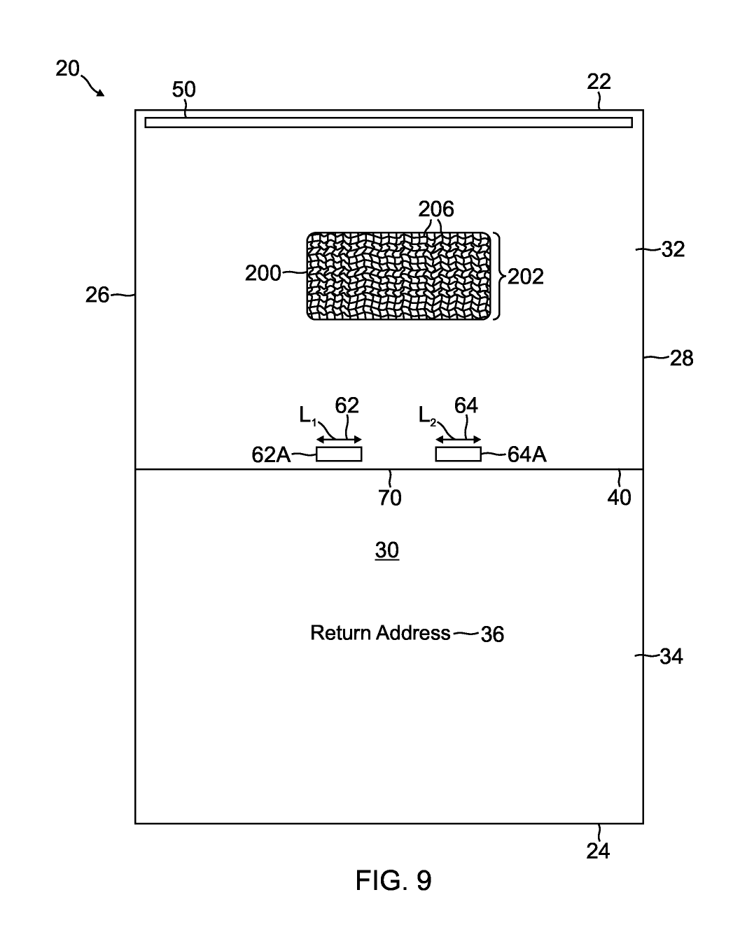

Referring to FIG. 9, the intermediate form 10 according to the invention shown in FIG. 1A is illustrated including the security feature 200 shown in and described above with reference to FIGS. 7 and 8. As mentioned, any of the configurations of the intermediate form 10 and the double postcard 12 shown in and described above with reference to FIGS. 1A-6B may include one or more security features 200 as described.

Referring to FIGS. 10A and 10B, any of the configurations of the intermediate form 20 according to the invention may be folded along the fold line 40 to the double postcard configuration 12 according to the invention. FIG. 10A illustrates the intermediate form 20 configured with one or more security features 200 in a folding orientation, such as shown by arrow 80. FIG. 10B illustrates the intermediate form 20 in a folded condition as a double postcard 12. Any of the applications of adhesive as are described above with reference to FIGS. 1A-9 help to secure the folded intermediate 20 in the folded double postcard configuration 12.

In addition, one or more securing features or devices may be used in addition to and/or as an alternative to any of the applications of adhesive of the intermediate forms 10 and 20 and the double postcards 12 as are described above with reference to FIG. 1A thru FIG. 9. As shown in FIG. 10B, such securing features or devices may include wafer seals, adhesive stickers, labels and/or decals 210 that are affixed along one or more end edges 20 and 22 of the intermediate forms 20 and the double postcard 12 and are disposed to retain the double postcard 12 in a closed condition. While FIG. 10B illustrates the intermediate form 20 according to the invention, those of ordinary skill in the art will appreciate that the intermediate forms 10 and the double postcards 12 described above with reference to FIGS. 1A-6B may include one or more wafer seals, adhesive stickers, labels and/or decals 210 in addition to and/or as an alternative to any of the applications of adhesive as are described above with reference to FIGS. 1A-6B.

Having thus described at least one illustrative aspect of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. An intermediate form for folding to a mailer having postcard dimensions, the intermediate form comprising:
a single ply of stock having a first face and a second face, a first and a second end edge, and a first and a second side edge, the first and the second side edges being disposed in a substantially perpendicular orientation to the first and the second end edges;
a fold line extending at a substantially transverse orientation to and between the first and the second side edges, the fold line being disposed to define at least a first panel and at least a second panel with at least one panel having postcard dimensions;
at least one security feature disposed along one face of the intermediate form, such that, when the intermediate form folds along the fold line, the at least one security feature is disposed along an inner surface of the folded intermediate form;
the at least one security feature including one or more thermochromic inks, each thermochromic ink being configured to temporarily change color in response to changes in temperatures of the thermochromic ink; and
private or sensitive information or indicia disposed along at least a portion of the at least one security feature.

2. The intermediate form of claim 1 wherein at least a portion of the private or sensitive information or indicia being disposed under the at least one security feature.

3. The intermediate form of claim 1 wherein at least a portion of the private or sensitive information or indicia being disposed over the at least one security feature.

4. The intermediate form of claim 1 wherein the at least one security feature includes a pattern of the one or more thermochromic inks.

5. The intermediate form of claim 4 wherein the pattern includes at least one of: one or more letters, one or more numbers, and one or more other configurations.

6. The intermediate form of claim 1 wherein the at least one security feature includes one or more thermochromic inks having different colors.

7. The intermediate form of claim 1 wherein the at least one security feature includes one or more layers of the one or more thermochromic inks.

8. The intermediate form of claim 1 wherein the one or more thermochromic inks define the at least one security feature so that the private or sensitive information or indicia are at least partially camouflaged.

9. The intermediate form of claim 1 wherein a temporary change color of each thermochromic ink permits at least a portion of the private or sensitive information or indicia to be temporarily and at least partially visible.

10. The intermediate form of claim 1 wherein the changes in temperatures of each thermochromic ink include increases in temperatures.

11. The intermediate form of claim 1 wherein the fold line being configured to permit the intermediate form to fold along the fold line to form a double postcard mailer having postcard dimensions.

12. The intermediate form of claim 12 wherein the double postcard mailer includes recipient information along an outer surface and return addressee information along the inner surface.

13. The intermediate form of claim 1 comprising at least a first application of adhesive disposed adjacent to at least the first or the second end edge and extending along at least a portion of the end edge.

14. The intermediate form of claim 13 comprising a second application of adhesive disposed adjacent to the fold line and substantially near a center point along the fold line, the center point being disposed substantially equidistant from the first and the second side edges and the second application of adhesive being disposed closer to the center point than to the first side edge or the second side edge.

15. The intermediate form of claim 14 wherein the first application and the second application of adhesive include at least one of: pressure sensitive cohesive, pressure sensitive adhesive, re-moist adhesive, hot or cold melt adhesive and hot or cold melt glue.

16. An intermediate form for folding to a mailer having postcard dimensions, the intermediate form comprising:
a single ply of stock having a first face and a second face, a first and a second end edge, and a first and a second side edge, the first and the second side edges being disposed in a substantially perpendicular orientation to the first and the second end edges;
a fold line extending at a substantially transverse orientation to and between the first and the second side edges, the fold line being disposed to define at least a first panel and at least a second panel with at least one panel having postcard dimensions;
a first application of adhesive disposed adjacent to the first end edge and extending along at least a portion of the first end edge, and a second application of adhesive disposed adjacent to the second end edge and extending along at least a portion of the second end edge;
at least one security feature disposed along one face of the intermediate form, such that, when the intermediate form folds along the fold line, the at least one security feature is disposed along an inner surface of the folded intermediate form;
the at least one security feature including one or more thermochromic inks, each thermochromic ink being configured to temporarily change color in response to changes in temperatures of the thermochromic ink; and
private or sensitive information or indicia disposed along at least a portion of the at least one security feature.

17. A double postcard mailer having postcard dimensions, the double postcard mailer comprising:
a single ply of stock having a first face and a second face, a first and a second end edge, and a first and a second side edge, the first and the second side edges being disposed in a substantially perpendicular orientation to the first and the second end edges;
a fold line extending at a substantially transverse orientation to and between the first and the second side edges, the fold line being disposed to define at least a first panel and at least a second panel with at least one panel having postcard dimensions and being configured to permit the single ply to fold along the fold line to form the double postcard mailer;
a first application of adhesive disposed adjacent to the first end edge and extending along at least a portion of the first end edge, and a second application of adhesive disposed adjacent to the second end edge and extending along at least a portion of the second end edge;
at least one security feature disposed along one face of the intermediate form, such that, when the intermediate form folds along the fold line, the at least one security feature is disposed along an inner surface of the folded intermediate form;
the at least one security feature including one or more thermochromic inks, each thermochromic ink being configured to temporarily change color in response to changes in temperatures of the thermochromic ink; and
private or sensitive information or indicia disposed along at least a portion of the at least one security feature.
